(19) United States
(12) Patent Application Publication
(10) Pub. No.: US 2004/0227270 A1
(43) Pub. Date: Nov. 18, 2004

(54) Method of double color-molding a key top

(75) Inventors: Masanori Takebe, Tokyo (JP); Takashi Odagiri, Tokyo (JP)

Correspondence Address: MORGAN LEWIS & BOCKIUS LLP, 1111 PENNSYLVANIA AVENUE NW, WASHINGTON, DC, 20004, US

(73) Assignee: Uniden Corporation

(21) Appl. No.: 10/618,263

(22) Filed: Jul. 14, 2003

(30) Foreign Application Priority Data
May 14, 2003 (JP) 2003-136340

(51) Int. Cl. B29C 45/00

(52) U.S. Cl. 264/255; 264/328.7; 264/328.8

(57) ABSTRACT

An object of the present invention is to provide a method of double color-molding a key top that is superior in design. In order to achieve this object, according to the method of double color-molding a key top provided in the present invention, at a first shot, a light-permeable resin layer is injection-molded, and simultaneously, a convex portion that corresponds to a planar shape of a closed loop in a letter, figure, sign, etc., is formed on a back surface of the light-permeable layer. In a second shot, a light-shielding resin layer is injection-molded on both an outer region and an inner region which are defined by a convex pattern of the convex portion on the back surface of the light-permeable resin layer. Since a gate trace, which remains after performing the gate-cut on the light-shielding resin layer, resides inside the key top, it is invisible from the outside of the key top. In this way, the design of a key top can be improved.

### BACKGROUND

1. Field of the Invention

The present invention relates to a technology of double color-molding a key top that is used for inputs in various kinds of electric devices, such as mobile phones, telephone machines, facsimile machines, copiers, car stereos, car radios, and remote controllers.

2. Description of the Related Art

FIG. 8 is a plane view of a conventional double color-molded key top, and FIG. 9 is a cross-sectional view along the line 9-9 of FIG. 8. A key top 100 shown in these figures, which is molded in order to indicate the numeral “0” of a push button for a telephone machine, has a bilayer structure consisting of a light-shielding resin layer (non-light-transmittable layer) 80 and a light-permeable resin layer (light-transmittable layer) 90. The light-shielding resin layer 80 comprises: an outer part 80a to form an outer line of a numeral “0” which forms a closed curve; an inner part 80b to form an inner line of the numeral “0”; and an arm-shaped bridge 80c which connects both parts. A closed loop 101, which is in the shape of a closed curve defined by the outer part 80a and an inner part 80b, is filled with the light-permeable resin layer 90, and is constructed so that it is illuminated by a backlight to light up and indicate a numeral “0.”

In order to double color-mold a key top having such structure, a mold having a slide mechanism has been provided, and a hollow flow path to connect the outer part 80a and the inner part 80b has been formed using the sliding mechanism, and the light-permeable resin has been injected into the hollow flow path, thereby injection-molding the light-shielding resin layer 80 comprising the outer part 80a, the inner part 80b and the bridge 80c in one injection.

As shown in FIG. 8, however, the bridge 80c is injection-molded in such a manner that it passes behind the light-permeable resin layer 90 with which the closed loop 101 is filled. Therefore, there has been a problem that, when illuminated by a backlight, this bridge portion causes a shadow, resulting in a poor quality image, which is unfavorable in terms of design. This problem arises in double-color molding a key top for indicating not only the above numeral “0,” but also a letter, figure, sign, etc., having a closed loop, including alphabets such as “A,” “B” and “O,” Arabic numerals such as “4,” “6” and “8,” and signs such as “Δ, “◯” and “□.” As means for solving such problem, Patent Laid-Open Publication No. Hei 7-88884 and Patent Laid-Open Publication No. Hei 7-1506 provide technologies for double color-molding a key top using a metal mold having a special structure.

However, in the technologies described in Laid-Open Publication No. Hei 7-88884 and Patent Laid-Open Publication No. Hei 7-1506, the metal mold has a complicated structure.

### SUMMARY

Therefore, an object of the present invention is to resolve the aforementioned problem and provide a method of double color-molding a key top that is superior in design.

In order to achieve the object, the method of double color-molding a key top according to the present invention comprises the steps of: performing a first shot for injection-molding a light-permeable resin layer, onto which a convex pattern corresponding to a planar shape of a closed loop in a letter, figure, sign, etc., is transferred; and performing a second shot for injecting light-shielding resin from a back side of the key top into both the outer part and the inner part of the closed loop, which are defined by the convex pattern, to injection-mold the outer part that forms an outer line of the closed loop and the inner part that forms an inner line of the closed loop.

Thus, by injection-molding the light-shielding resin layer on the back surface of the light-permeable resin layer, a gate trace remains on the back surface of the light-shielding resin layer, and the gate trace can be made invisible from the outside of the key top. In this way, a key top, which is superior in design, can be obtained.

The method of double color-molding a key top according to the present invention comprises the steps of: closing an upper metal mold for a first shot including a core that has a concave portion with a concave pattern corresponding to a planar shape of a closed loop in a letter, figure, sign, etc., and that has a gate hole for injecting light-permeable resin, and a lower metal mold having a cavity for injecting light-permeable resin; performing a first shot for injecting light-permeable resin into a space formed between the core of the upper metal mold and the cavity of the lower metal mold through the gate hole to injection-mold a light-permeable resin layer; changing the upper metal mold for a first shot to an upper metal mold for a second shot including a gate hole for injection-molding with the light-shielding resin each of an outer part that forms an outer line of a closed loop and an inner part that forms an inner line of the closed loop; closing the upper metal mold for a second shot and the lower metal mold; and performing a second shot for injecting light-shielding resin into a space formed between a core of the upper metal mold for a second shot and the cavity of the lower metal mold through the gate hole to injection-mold the outer part and the inner part on a back surface of the light-permeable resin layer.

A depth of the concave portion formed on the core of the upper metal mold for a first shot is preferably no less than half of a thickness of the inner part or the outer part. By adjusting the depth of the concave portion in this way, the adhesion force of the light-shielding resin layer and the light-permeable resin layer at the time of a second shot molding can be enhanced, thereby preventing the separation of the light-shielding resin layer and the light-permeable resin layer when the upper metal mold for a second shot and the lower metal mold are opened.

### DESCRIPTION OF DRAWINGS

FIG. 1 illustrates a key top molding procedure according to this embodiment.

FIG. 2 illustrates a key top molding procedure according to this embodiment.

FIG. 3 illustrates a key top molding procedure according to this embodiment.

FIG. 4 illustrates a key top molding procedure according to this embodiment.

FIG. 5 is a plane view of a light-permeable resin layer according to this embodiment.

FIG. 6 is a plane view of a key top according to this embodiment.

FIG. 7 is a cross-sectional view along the 7-7 line in FIG. 6.

FIG. 8 is a plane view of a conventional key top.

FIG. 9 is a cross-sectional view along the 9-9 line in FIG. 8.

### DESCRIPTION OF THE PREFERRED EMBODIMENT

A preferred embodiment is explained below with reference to the drawings.

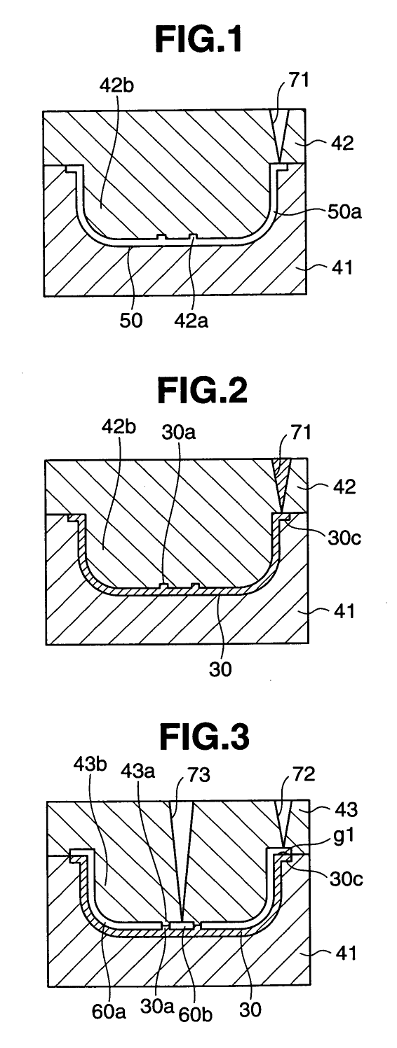

FIGS. 1 to 4 show the procedures in the method of double color-molding a key top according to this embodiment. In these figures, 41 is a lower metal mold which is used for both a first shot and a second shot, 42 is an upper metal mold which is used for a first shot, and 43 is an upper metal mold which is used for a second shot. The lower metal mold 41 comprises a cavity 50 for injecting light-permeable resin, which is formed in a concave shape from a cross-sectional viewpoint.

The upper metal mold 42 is a mold for injection-molding a light-permeable resin layer at the time of a first shot, and has a core 42b formed in a concave shape from a cross-sectional viewpoint, that may fit within the cavity 50 leaving a predetermined gap. The core 42b comprises a concave portion 42a that has a concave pattern corresponding to a planar shape of a closed loop in a letter, figure, sign, etc., that is to be pattern-molded into a light-permeable resin layer at the time of the first shot. Further, the upper metal mold 42 comprises a gate hole (resin injection hole) 71 for injecting light-permeable resin into a position in which an edge 30c (see FIG. 2) of the light-permeable resin layer is to be formed. As shown in FIG. 2, when the lower metal mold 41 and the upper metal mold 42 are compression-bonded in a state in which both metal molds are closed under an adequate pressure, a space 50a is formed between the core 42b and the cavity 50.

Next, as shown in FIG. 2, in the first shot, when melt light-permeable resin is injected into the gate hole 71, the space 50a is filled with the light-permeable resin. When this light-permeable resin is cooled and solidified, the light-permeable resin filled in the space 50a becomes a light-permeable resin layer 30. When the light-permeable resin that has been injected into the concave portion 42a is cooled and solidified, it becomes a convex portion 30a. A convex pattern of the convex portion 30a is a pattern that is formed by reversing the concavity and convexity of the concave pattern of the concave portion 42a. The gate hole 71 formed in the upper metal mold 42 may be placed in any position in which a gate trace is invisible from an outside perspective in a state in which the key top is incorporated into an electric device. In other words, such position may be any position in which a light-shielding resin layer is not formed in the second shot. A preferable example of such positions is a back surface of the edge (flange) 30c of the light-permeable resin layer 30. In the gate-cut described later, a gate trace g1 (see FIG. 3) is formed on the edge 30c. However, in the state in which the key top is incorporated in an electric device, such as a mobile phone, the gate trace g1 is difficult to see and is quite inconspicuous, which is favorable in terms of design.

FIG. 5 is a plane view of a light-permeable resin layer formed in the first shot (a half-finished product). On the back surface of the light-permeable resin layer 30, the convex portion 30a, which has a convex pattern that corresponds to a planar shape of a closed loop in a letter, figure, sign, etc., is formed. Here, a numeral “0” is used as an example of a closed loop. In the second shot described later, the convex portion 30a functions as a separation member for separation-molding an outer part that forms an outer line of a closed loop in a letter, figure, sign, etc., and an inner part that forms an inner line of the closed loop.

When the first shot has been completed, the lower metal mold 41 and the upper metal mold 42 have been opened, a gate-cut has been performed on the solidified light-permeable resin layer 30, and the upper metal mold 42 for a first shot has been replaced with the upper metal mold 43 for a second shot, then the state becomes as shown in FIG. 3. The upper metal mold 43 for a second shot comprises a core 43b, which is in a convex shape from a cross-sectional viewpoint, that may fit within the cavity 50 leaving a predetermined gap. The core 43b includes a convex portion 43a having a convex pattern in a shape of a closed curve, which conforms to a convex pattern of the convex portion 30a of the light-permeable resin layer 30. That is, the convex pattern of the convex portion 43a is a pattern that is formed by reversing the concavity and convexity of the concave pattern of the concave portion 42a.

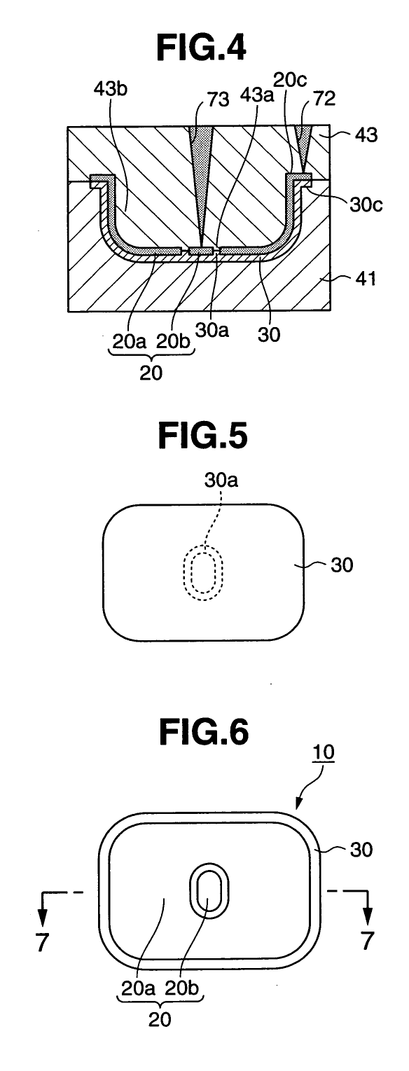

As shown in FIG. 3, when the lower metal mold 41 and the upper metal mold 43 are compression-bonded in a state in which both are closed under an adequate pressure, the convex portion 43a and the convex portion 30a are adhered together without gaps, and spaces 60a and 60b for injection-molding a light-shielding resin layer are formed between the cavity 50 of the lower metal mold 41 and the core 43b of the upper metal mold 43. The space 60a is a gap for injection-molding an outer part that forms an outer line of a closed loop in a letter, figure, sign, etc., and the cavity shape 60b is a gap for injection-molding an inner part that forms an inner line of the closed loop. Gate holes 72 and 73 for injecting light-shielding resin are provided in positions connected respectively to the spaces 60a and 60b. Next, as shown in FIG. 4, melt light-shielding resin is injected from the gate holes 72 and 73 to fill the inside of the spaces 60a and 60b with light-permeable shielding resin. Since the convex portion 43a and the convex portion 30a are adhered together without gaps, the light-shielding resin cannot flow in between the convex portion 43a and the convex portion 30a. A perferable example of light-shielding resin is ABS resin of a blackish color. When the light-shielding resin filled in the spaces 60a and 60b is cooled and solidified, a light-shielding resin layer 20a is formed in the outer part that forms an outer line of a closed loop in a letter, figure, sign, etc., and a light-shielding resin layer 20b is formed in an inner part that forms an inner line of the closed loop. The light-shielding resin layer 20a and 20b is melt welded to the light-permeable resin layer 30.

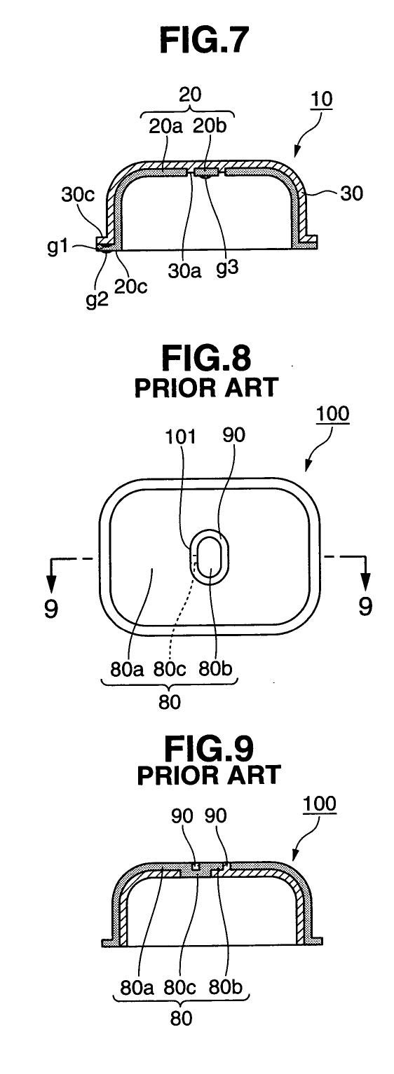

FIG. 6 is a plane view of a key top 10 molded by the second shot, and FIG. 7 is a cross-sectional diagram along the line 7-7 of FIG. 6. As shown in these figures, the light-shielding resin layer 20a is bonded to a back surface of the light-permeable resin layer 30 in an outer region defined by the convex pattern of the convex portion 30a. Further, the light-shielding resin layer 20b is bonded to the back surface of the light-permeable resin layer 30 in an inner region defined by the convex pattern of the convex portion 30a. Preferably, a height of the convex portion 30a (a depth of the concave portion 42a) is approximately no less than half of a thickness of the light-shielding resin layer 20a and 20b. By adjusting the height of the convex portion 30a to the above value, the light-shielding resin layer 20b is sandwiched and thereby secured in the inside of the convex portion 30a in a shape of a closed curve, so that the adhesion force of the light-shielding resin layer 20b and the light-permeable resin layer 30 can be enhanced. In this way, when the upper metal mold 43 and the lower metal mold 41 are separated, the separation of the light-shielding resin layer 20a and 20b, and the light-permeable resin layer 30, due to the light-shielding resin layer 20a and 20b sticking to the core 43b, can be prevented.

According to the method of double color-molding a key top according to this embodiment, when the lower metal mold 41 and the upper metal mold 43 are separated and a gate-cut of an injection gate for light-permeable resin is performed, gate traces g2 and g3 are left on the back surfaces of the edge 20c of the light-shielding resin layer 20a, and the light-shielding resin layer 20b, respectively, as shown in FIG. 7, and therefore, these gate traces g2 and g3 are invisible from the outside of the key top 10, which is favorable in terms of design. Further, since there is no bridge connecting the light-shielding resin layer 20a and 20b as opposed to the related art, a problem does not arise in which a bridge causes a shadow when illuminated by a back light.

We claim:

1. A method of double color-molding a key top, comprising the steps of:
performing a first shot for injection-molding a light-permeable resin layer, onto which a convex pattern corresponding to a planar shape of a closed loop in a letter, figure, sign, or the like, is transferred; and
performing a second shot for injecting light-shielding resin from a back side of said key top into both said outer part and said inner part of said closed loop, which are defined by said convex pattern, to injection-mold said outer part that forms an outer line of said closed loop and said inner part that forms an inner line of said closed loop.

2. A method of double color-molding a key top, comprising the steps of:
closing an upper metal mold for a first shot including a core that has a concave portion with a concave pattern corresponding to a planar shape of a closed loop in a letter, figure, sign, or the like, and that has a gate hole for injecting light-permeable resin, and a lower metal mold having a cavity for injecting light-permeable resin;
performing a first shot for injecting light-permeable resin into a space remaining between said core of said upper metal mold and said cavity of said lower metal mold through said gate hole to injection-mold a light-permeable resin layer;
changing said upper metal mold for a first shot to an upper metal mold for a second shot including a gate hole for injection-molding with the light-shielding resin each of an outer part that forms an outer line of a closed loop and an inner part that forms an inner line of said closed loop;
closing said upper metal mold for a second shot and said lower metal mold; and
performing a second shot for injecting light-shielding resin into a space remaining between a core of said upper metal mold for a second shot and said cavity of said lower metal mold through said gate hole to injection-mold said outer part and said inner part on a back surface of said light-permeable resin layer.

3. A depth of said concave portion formed on said core of said upper metal mold for a first shot is preferably no less than half of a thickness of said inner part or said outer part.
